(19) United States
(12) Patent Application Publication
(10) Pub. No.: US 2010/0178038 A1
(43) Pub. Date: Jul. 15, 2010

(54) VIDEO PLAYER

(75) Inventor: Chi-Cheng Ju, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/352,006

(22) Filed: Jan. 12, 2009

(51) Int. Cl. H04N 7/26; H04N 7/12; H04N 5/50

(52) U.S. Cl. 386/109; 375/240.16; 348/569; 375/E07.076; 348/E05.097

(57) ABSTRACT

A video player including a memory, a video decoder and a frame rate converter. The video decoder decodes a video bitstream to output decoded video to the memory and output first motion vector information encoded in the video bitstream. The frame rate converter, coupled to the video decoder, receives the first motion vector information and performs the frame rate conversion on the decoded video from the memory to generate a frame-rate converted video for display according to the first motion vector information.

### BACKGROUND OF THE INVENTION

1. Field of the Invention

The invention relates to video players.

2. Description of the Related Art

For file/movie/animation sources, the frame rate is about 24-30 frames/sec. Normal display devices, however, are usually designed to display videos with frame rates of about 50-60 frames/sec. Thus, frame rate conversion is required to up-convert the frame rate of the source video for displaying in display devices.

One conventional way of frame rate up-conversion is frame repetition, wherein frames of the source video are repeated to increase the frame rate. However, frame repetition causes judder artifact when the object or background of the video is moving. Thus, to get smoother videos, motion estimation/motion compensation (ME/MC) technique has been adopted in frame rate conversion.

FIG. 1A shows an example of the motion estimation (ME) technique. Frame 102 is a current frame, and frame 104 is a previous frame. To find the best-match blocks in frames 102 and 104, the motion estimation technique uses a search window 108 to scan frame 104. For example, block 110 is identified as the best-match block of block 106 and a motion vector MV indicating the position relation between blocks 106 and 110 is calculated.

FIG. 1B shows an example of the motion compensation (MC) technique utilized in ME/MC frame rate conversion. There is a motion vector between block 120 of frame(N-1) and block 122 of frame(N). Based on the motion vector and the image data of blocks 120 and 122, the motion compensation technique generates the image data of block 124. Similarly, an interpolated frame 126 can be generated by implementing the motion compensation technique over the entire frame. Since the motion of the objects or the background is considered during the ME/MC frame rate conversion, the frame-rate converted video using the ME/MC technique results in much smoother videos than that using the frame repetition technique.

Therefore, video processing apparatuses equipped with video decoder and ME/MC frame rate conversion become popular in recent years.

### BRIEF SUMMARY OF THE INVENTION

The invention provides video players with frame rate conversion.

An exemplary embodiment of the video players of the invention comprises a memory, a video decoder and a frame rate converter. The video decoder decodes a video bitstream to output decoded video to the memory and output first motion vector information encoded in the video bitstream. The frame rate converter is coupled to the video decoder to receive the first motion vector information. According to the first motion vector information, the frame rate converter performs a frame rate conversion on the decoded video from the memory to generate a frame-rate converted video.

Another exemplary embodiment of the video players of the invention comprises a memory, a video decoder and a frame rate converter. The video decoder decodes a video bitstream, outputs the decoded video to the memory, and outputs side information decoded from the video bitstream to the frame rate converter. The frame rate converter retrieves the decoded video from the memory, and generates frame-rate converted video according to the side information.

Another exemplary embodiment of the video players of the invention comprises an on-screen display (OSD) circuit, a frame rate converter and an image mixer. In addition to outputting an OSD, the OSD circuit outputs an OSD region indicator indicating an OSD region displaying the OSD. The frame rate converter retrieves a decoded video and receives the OSD indicator. The frame rate converter performs a frame rate conversion on the decoded video to generate a frame-rate converted video according to the OSD region indicator. The image mixer mixes the OSD into the frame-rate converted video for display.

Another exemplary embodiment of the video players of the invention comprises a memory, a video decoder, an OSD circuit, an image mixer, a controller and a frame rate converter. The video decoder decodes a video bitstream to output decoded video. The OSD circuit generates an OSD. The image mixer mixes the OSD into the decoded video to generate mixed video and stores the mixed video in the memory. The frame rate converter retrieves the mixed video from the memory and performs a frame rate conversion on the mixed video. The controller detects the state of the OSD circuit and locates an OSD region displaying the OSD, and outputs a control signal to the frame rate converter to disable a motion estimation/motion compensation function of the frame rate converter when the frame rate converter performs the frame rater conversion in the OSD region

Another exemplary embodiment of the video players of the invention comprises a memory, a video decoder, a frame rate converter, and a memory controller. The video decoder and the frame rate converter communicate with the memory via the memory controller, and the memory controller dynamically allocates the memory to the video decoder or the frame rate converter.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1A illustrates a motion estimation technique;

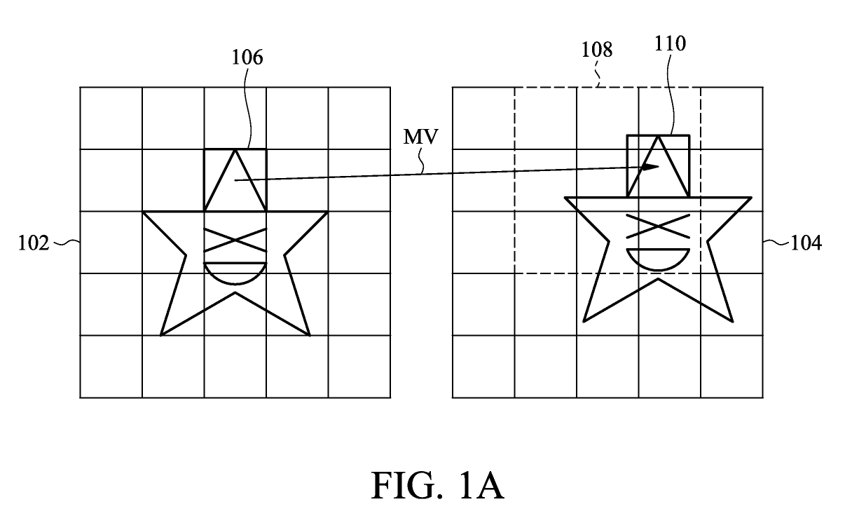

FIG. 1B illustrates a motion compensation technique;

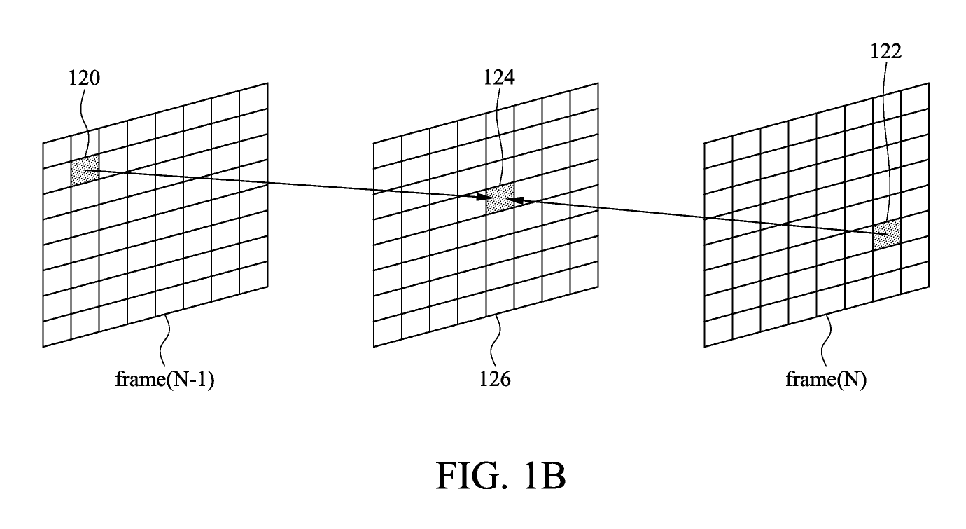

FIG. 2 illustrates an embodiment of the video player of the invention;

FIG. 3 illustrates another embodiment of the video player of the invention;

FIG. 4 illustrates another embodiment of the video player of the invention;

FIG. 5 illustrates another embodiment of the video player of the invention;

FIG. 6 illustrates another embodiment of the video player of the invention;

FIG. 7 illustrates another embodiment of the video player of the invention; and

FIG. 8 illustrates another embodiment of the video player of the invention.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

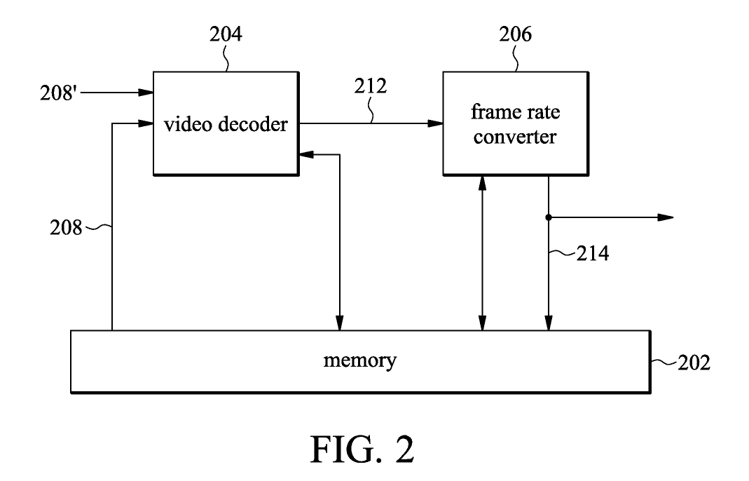

FIG. 2 shows an embodiment of a video player of the invention, which comprises a memory 202, a video decoder 204 and a frame rate converter 206. According to a video bitstream (signal 208, fetched from the memory 202, or signal 208′, retrieved from other devices), the video decoder 204 outputs decoded video to the memory 202 and outputs first motion vector information 212 that is generally encoded in the video bitstream 208 or 208′ for video compression. In conventional video processing apparatuses, the first motion vector information is only utilized in constructing the decoded video. The video decoder 204, however, further outputs the first motion vector information 212 to the frame rate converter 206, allowing the frame rate converter 206 to perform a frame rate conversion therewith. The frame rate converter 206 performs the frame rate conversion on the decoded video retrieved from the memory 202 according to the first motion vector information 212 and generates a frame-rate converted video 214 to be displayed in display devices. In some embodiments, the frame-rate converted video 214 is stored in the memory 202 to be retrieved by display devices; and in other cases, the frame-rate converted video 214 may be directly output to and displayed in display devices where the storage in the memory 202 is not required.

Upon receiving first motion vector information 212, the frame rate converter 206 sets parameters of the frame rate conversion therewith for performing the frame rate conversion. For example, large first motion vector information 212 may imply large object motion in the decoded video. Thus, a motion estimation function of the frame rate conversion is set to have a wider search window when the value of the first motion vector information 212 exceeds a first predetermined threshold, and to have a narrower search window when the value of the first motion vector information 212 is less than a second predetermined threshold. With the search window refinement in accordance with the value of the first motion vector information 212, the computations of the frame rate converter 206 is reduced. Alternatively, the frame rate converter 206 may select one ME algorithm from a plurality of ME algorithms according to the first motion vector information 212. For example, when the first motion vector information 212 exceeds a third predetermined threshold, the frame rate converter 206 may select an algorithm with wider search window for performing frame rate conversion, such as 3-step search method. Conversely, when the first motion vector information 212 is less than a fourth predetermined threshold, the frame rate converter 206 may select an algorithm with narrower search window for performing frame rate conversion, such as full search method.

In some embodiments, when the value of the first motion vector information 212 is greater than a threshold level, the frame rate converter 206 may use a simpler technique, such as frame repetition, to replace a motion estimation/motion compensation function of the frame rate conversion. It's because with large motion, users may not observe judder artifact result by motions of objects in frames.

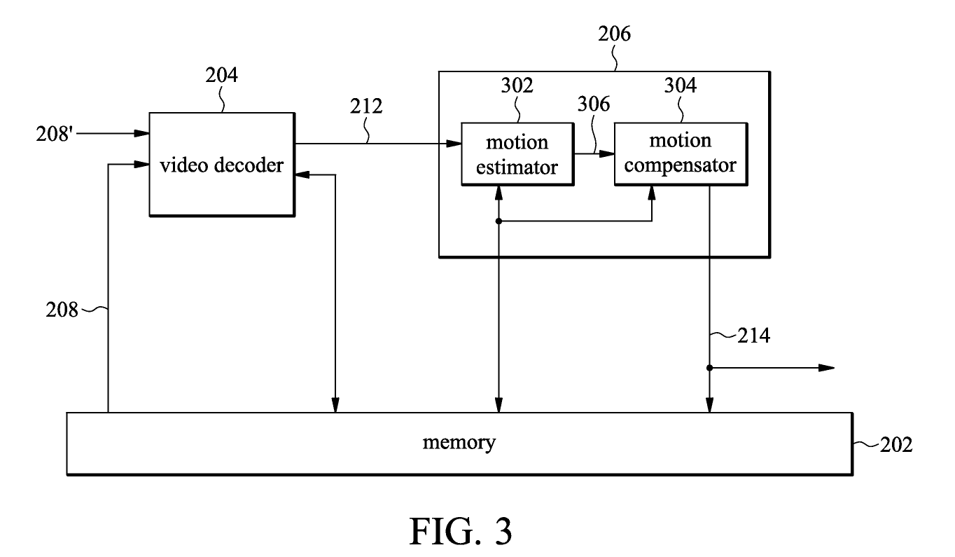

FIG. 3 illustrates a video player according to another embodiment of the invention. The frame rate converter 206 comprises a motion estimator 302 and a motion compensator 304 for performing motion estimation and motion compensation respectively. The motion estimator 302 generates a second motion vector information 306 according to the decoded video (retrieved from the memory 202) and the first motion vector information 212. The motion compensator 304 generates the frame-rate converted video 214 based on the second motion vector information 306 and the decoded video. Compared to conventional motion estimation technique that is based on the decoded video only, the first motion vector information 212 significantly simplifies the motion estimation procedure of the motion estimator 302, and the second motion vector information 306 is generated efficiently.

The motion estimator 302 may take the first motion vector information 212 as the initial value for locating the second motion vector information 306. For a current block of a current frame, when a neighboring block of the current block has a first motion vector information 212 equal to the first motion vector information 212 of the current block, the motion estimator 302 may directly use the second motion vector information 306 of the neighboring block as the second motion vector information 306 of the current block. Alternatively, the second motion vector information 306 of the neighboring block may be utilized as the initial value for locating the second motion vector information 306 of the current block. Further, when the difference between the first motion vector information 212 of the neighboring block and the current block is less than a predetermined value, the motion estimator 302 may similarly directly use the second motion vector information 306 of the neighboring block as the second motion vector information 306 of the current block or for locating the second motion vector information 306 of the current block.

In some embodiments, the motion estimator 302 generates the second motion vector information 306 by searching for a best-match block in related frames with a search range determined based on the first motion vector information 212. The size of the search range may be determined according to the value of the first motion vector information 212, wherein a larger search range would be selected for a larger first motion vector information 212 value and vice versa.

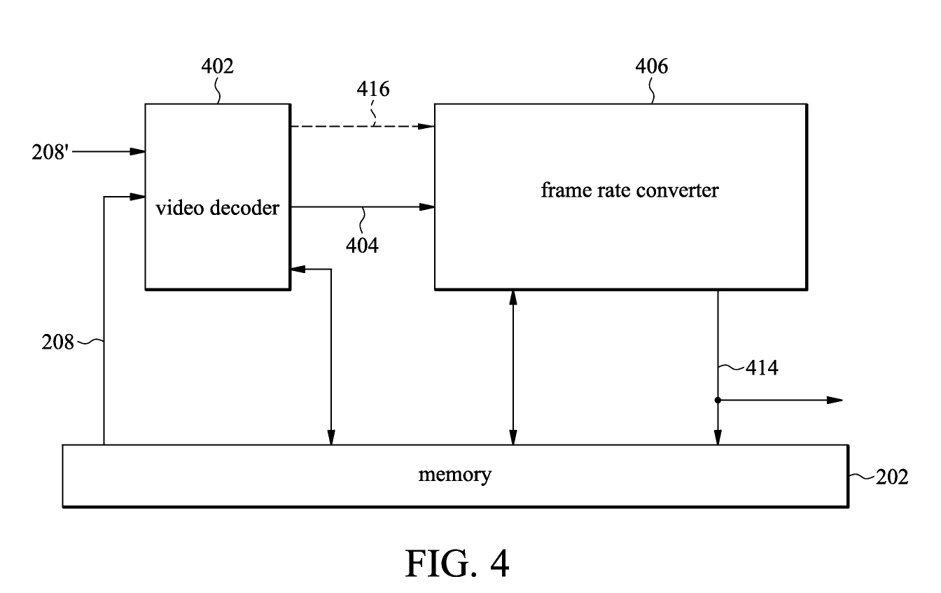

FIG. 4 illustrates a video player according to still another embodiment of the invention. As shown, the video decoder 402 outputs side information 404, such as telecine information or scanning mode information, decoded from the video bitstream 208 or 208′. The telecine information is generally encoded in the video bitstream 208 or 208′ to indicate that the video bitstream 208 or 208′ is film video of 24 frames/sec, National Television Standards Committee (NTSC) video signal of 60 frames/sec or Phase Alternating Line (PAL) video signal with the frame rate of 50 frames/sec. The telecine information is also known as 3:2 pull down information or 2:2 pull down information. The scanning mode is generally encoded in the video bitstream 208 or 208′ to indicate that the video is in an interlacing mode or in a progressive mode. Referring to FIG. 4, the video player comprises the video decoder 402 and a frame rate converter 406. The video decoder 402 decodes the video bitstream 208 or 208′ and outputs decoded video to the memory 202 and the side information 404 decoded from the video bitstream 208 or 208′ to the frame rate converter 406. The frame rate converter 406 retrieves the decoded video from the memory 202 and performs frame rate conversion on the decoded video according to the side information 404 to generate frame-rate converted video 414. The frame-rate converted video 414 can be stored in the memory 202 or sent to displays for displaying directly.

When the side information 404 is telecine information indicating the decoded video is 3:2 or 2:2 pull down converted, the frame rate converter 406 further performs respective 3:2 or 2:2 pull down reverse process on the decoded video before performing the frame rate conversion.

When the side information 404 is scanning mode information indicating an interlacing mode, the frame rate converter 406 further performs a de-interlacing procedure to convert the decoded video from the interlacing mode to the progressive mode before performing the frame rate conversion. Thus, the processed decoded video 412 is guaranteed to be in the progressive-mode.

Because the side information is obtained by the video decoder 402, the invention does not need an additional circuit, such as a 3:2 pull down detection circuit, for detecting and determining the side information.

In additional to the side information, the video decoder 402 may further output color format information (for example, 4:4:4, 4:2:0, 4:2:2 or 4:1:1 color format) and/or frame rate information via the signal line 416. The color format information and the frame rate information are generally encoded in the video bitstream 208 or 208′ to indicate the color format and the frame rate of the video, respectively. The video decoder 402 may decode the color format information and the frame rate information from the video bitstream 208 208′ and output any one or both of them. According to the color format and/or frame rate information transmitted by the signal line 416, the frame rate converter 406 generates a frame-rate converted video 414 according to the color format or/and frame rate information.

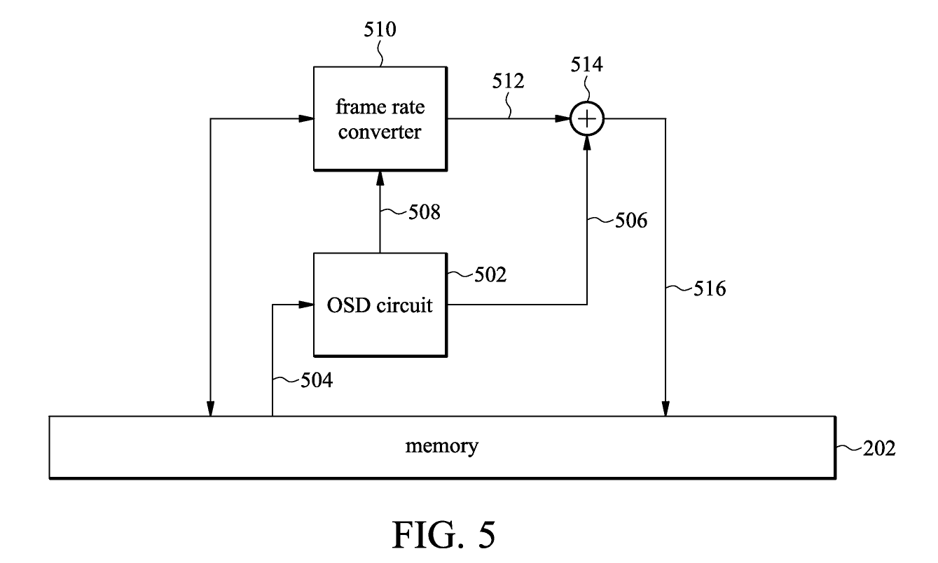

FIG. 5 illustrates a video player according to another embodiment of the invention. The on-screen display (OSD) circuit 502 may retrieve OSD data 504 from the memory 202. Based on the OSD data 504, the OSD circuit 502 generates an OSD 506 and an OSD region indicator 508 indicating an OSD region of the OSD 506. In addition to retrieving the decoded video from the memory 202, frame rate converter 510 is coupled to the OSD circuit 502 to receive the OSD region indicator 508. The frame rate converter 510 performs a frame rate conversion on the decoded video to generate a frame-rate converted video 512, wherein, according to the OSD region indicator 508, the frame rate converter 510 may omit the frame rate conversion within the OSD region indicated by the OSD region indicator 508 or selects a simpler frame rate conversion algorithm for performing the frame rate conversion in the OSD region indicated by the OSD region indicator 508. Alternatively, the frame rate converter 510 may disable a motion estimation/motion compensation function of the frame rate conversion in the OSD region indicated by the OSD region indicator 508, but perform a frame rate conversion without MJC function, such as frame repetition. An image mixer 514 further mixes the OSD 506 with the frame-rate converted video 512 to generate the displayed video 516 for displaying on displays. The image mixer 514 may store the displayed video 516 in the memory 202 to be retrieved by displays or directly pass the displayed video 516 to displays without through the memory 202.

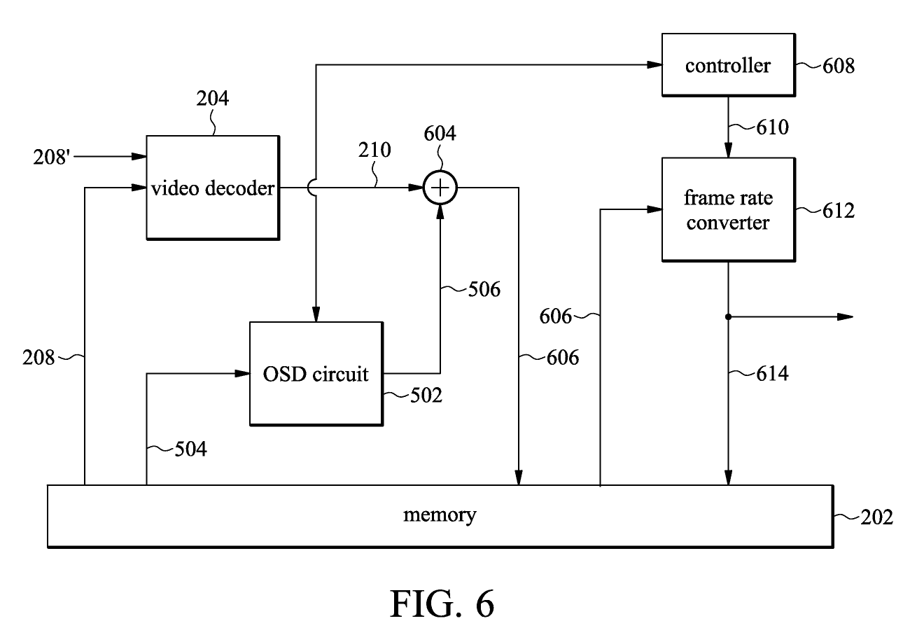

FIG. 6 illustrates a video player according to another embodiment of the invention. The video decoder 204 decodes a video bitstream 208 or 208′ and outputs decoded video 210. The OSD circuit 502 may retrieve OSD data 504 from the memory 202, and generate the OSD 506 based on the OSD data 504. The mixer 604 mixes the OSD 506 with the decoded video 210, and outputs a mixed video 606 to the memory 202. The controller 608 detects the state of the OSD circuit 502, locates an OSD region of the OSD 506, and outputs a control signal 610 to the frame rate converter 612. The frame rate converter retrieves the mixed video 606 from the memory 202 and performs a frame rate conversion on the mixed video 606 to generate displayed video 614. Under the control of the control signal 610, a motion estimation/motion compensation function of the frame rate converter 612 is disabled at the OSD region. The displayed video 614 may be output to displays directly or further via the memory 202.

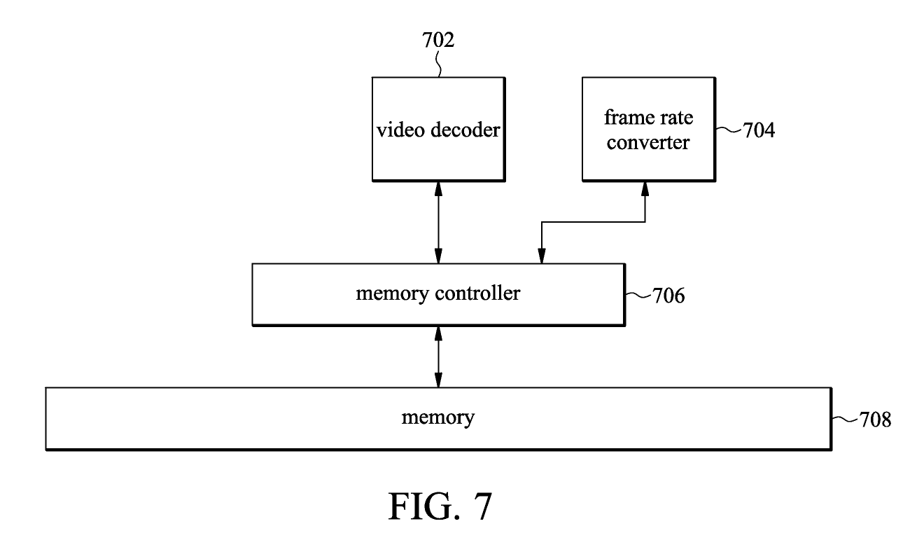

FIG. 7 illustrates a video player according to another embodiment of the invention. The video player comprises a video decoder 702, a frame rate converter 704, a memory controller 706 and a memory 708. The video decoder 702 may retrieve a video bitstream from the memory 708 via the memory controller 706 and stores the decoded video to the memory 708 via the memory controller 706. The frame rate converter 704 retrieves the decoded video from the memory 708 via the memory controller 706, performs frame rate conversion on the decoded video, and stores frame-rate converted video to the memory 708 via the memory controller 706. The memory controller 706 dynamically allocates the memory 708 to the video decoder 702 and the frame rate converter 704. Thus, the memory space of the memory 708 is dynamically allocated to store the decoded video and the frame-rate converted video. That is, when the frame rate converter 704 is disabled, the memory space therefor can be reallocated to the video decoder 702, and vice versa.

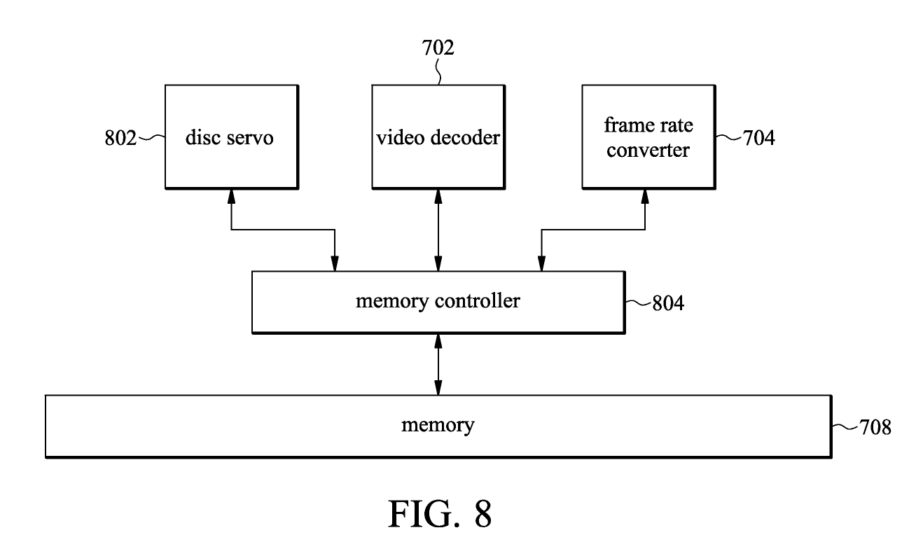

FIG. 8 illustrates a video player according to another embodiment of the invention. Compared to FIG. 7, the video player of FIG. 8 further comprises a disc servo 802 for reading data from a disk. In this embodiment, the disc servo 802, video decoder 702 and the frame rate converter 704 all communicate with the memory 708 by the memory controller 804, and the memory controller 804 dynamically allocates the memory 708 to the disc servo 802, video decoder 702 and frame rate converter 704. That is, when the frame rate converter 704 is disabled, the memory space therefor can be reallocated to the video decoder 702 and/or the disc servo 802. Similarly, when the video decoder 702 is disabled, the memory space therefor can be reallocated to the frame rate converter 704 and/or the disc servo 802. When the disc servo 802 is disabled, the memory space therefor can be reallocated to the frame rate converter 704 and/or the video decoder 702.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A video player, comprising:
a memory;
a video decoder, decoding a video bitstream to output decoded video to the memory, and outputting first motion vector information encoded in the video bitstream; and
a frame rate converter coupled to the video decoder, receiving the first motion vector information, and performing a frame rate conversion on the decoded video from the memory according to the first motion vector information to generate a frame-rate converted video.

2. The video player as claimed in claim 1, wherein, according to the value of the first motion vector information, the frame rate converter sets a search window of a motion estimation function of the frame rate converter.

3. The video player as claimed in claim 1, wherein the frame rate converter disables a motion estimation/motion compensation function of the frame rate converter when the first motion vector information is larger than a threshold level.

4. The video player as claimed in claim 1, wherein the frame rate converter further comprises a motion estimator and a motion compensator, wherein the motion estimator generates second motion vector information based on the first motion vector information and the decoded video, and the motion compensator generates the frame-rate converted video based on the second motion vector information and the decoded video.

5. The video player as claimed in claim 4, wherein the motion estimator takes the first motion vector information as initial value for generating the second motion vector information.

6. The video player as claimed in claim 4, wherein, for a current block of a current frame, the motion estimator directly takes the second motion vector information of a neighboring block of the current block to be the second motion vector information of the current block when the difference between the first motion vector information of the neighboring block and the current block is less than a predetermined threshold.

7. The video player as claimed in claim 4, wherein the motion estimator generates the second motion vector information with a search range determined based on the first motion vector information.

8. The video player as claimed in claim 7, wherein the size of the search range is determined according to the value of the first motion vector information.

9. The video player as claimed in claim 1, wherein, according to the value of the first motion vector information, the frame rate converter selects one motion estimation algorithm from a plurality of motion estimation algorithms for performing the frame rate conversion.

10. A video player, comprising:
a memory;
a video decoder, decoding a bitstream, outputting decoded video into the memory, and outputting side information decoded from the bitstream; and
a frame rate converter, receiving the side information from the video decoder, retrieving the decoded video from the memory, and generating frame rate converted video according to the side information.

11. The video player as claimed in claim 10, wherein the side information is telecine information and, when the telecine information indicates 3:2 pull down or 2:2 pull down information, the frame rate converter further performs a respective 3:2 or 2:2 pull down reverse process on the decoded video before generating the frame rate converted video.

12. The video player as claimed in claim 10, wherein the side information is scanning mode information and when the scanning mode information indicates that the decoded video is in an interlacing mode, the frame rate converter further converts the decoded video from the interlacing mode to a progressive mode before generating the frame rate converted video.

13. The video player as claimed in claim 10, wherein the video decoder further outputs color format information decoded from the video bitstream, and the frame rate converter generates the frame-rate converted video according to the color format information.

14. The video player as claimed in claim 10, wherein the video decoder further outputs frame rate information decoded from the video bitstream, and the frame rate converter further generates the frame-rate converted video according to the frame rate information.

15. A video player, comprising:
an on-screen display (OSD) circuit, generating an OSD and outputting an OSD region indicator indicating an OSD region displaying the OSD;
a frame rate converter, retrieving a decoded video, receiving the OSD region indicator, and performing a frame rate conversion on the decoded video according to the OSD region indicator to generate a frame-rate converted video; and
an image mixer, mixing the OSD into the frame-rate converted video for display.

16. The video player as claimed in claim 15, wherein the frame rate converter omits the frame rate conversion in the OSD region indicated by the OSD indicator.

17. The video player as claimed in claim 15, wherein the frame rate converter selects a frame rate conversion algorithm for performing the frame rate conversion in the OSD region indicated by the OSD indicator.

18. The video player as claimed in claim 15, wherein the frame rate converter disables a motion estimation/motion compensation function thereof when performing the frame rate conversion in the OSD region indicated by the OSD indicator.

19. A video player, comprising:
a memory;
a video decoder, decoding a video bitstream and outputting decoded video;
an on-screen display (OSD) circuit, generating an OSD;
an image mixer, mixing the OSD into the decoded video to generate a mixed video and store the mixed video in the memory;
a frame rate converter, retrieving the mixed video from the memory and performing a frame rate conversion on the mixed video,
a controller, detecting the state of the OSD circuit and locating an OSD region displaying the OSD, and outputting a control signal to the frame rate converter to disable a motion estimation/motion compensation function of the frame rate converter when the frame rate converter performs the frame rater conversion in the OSD region.

20. A video player, comprising:
a memory;
a memory controller;
a video decoder, decoding a video bitstream, and outputting decoded video to the memory via the memory controller; and
a frame rate converter, retrieving the decoded video from the memory via the memory controller, performing a frame rate conversion on the decoded video to generate a frame-rate converted video, and storing the frame-rate converted video to the memory via the memory controller,
wherein the memory controller dynamically allocates the memory to the video decoder and the frame rate converter.

21. The video player as claimed in claim 20, wherein the video player further comprises a disk servo communicating with the memory via the memory controller, and the memory controller further dynamically allocates the memory to the disk servo.
